(19) United States
(12) Patent Application Publication
(10) Pub. No.: US 2026/0172381 A1
(43) Pub. Date: Jun. 18, 2026

(54) CONTEXT-AWARE ARTIFICIAL INTELLIGENCE AGENT FOR ENHANCED TEXT MESSAGING-BASED AUTHENTICATION

(71) Applicant: AT&T Intellectual Property I, L.P., Atlanta, GA (US)

(72) Inventors: Lars Johnson, Brooklyn, NY (US); Wei Wang, Montclair, NJ (US)

(21) Appl. No.: 18/983,333

(22) Filed: Dec. 16, 2024

(51) Int. Cl. H04L 51/216

(52) U.S. Cl. CPC H04L 51/216

(57) ABSTRACT

A processing system including at least one processor of an endpoint device may obtain an authentication request from a counterparty computing system via a first text message, where the authentication request is based on a context associated with at least one of: the endpoint device, a user of the endpoint device, or the counterparty computing system. The processing system may next retrieve contextual content in response to the authentication request, where the contextual content comprises information from a text message history between the endpoint device and the counterparty computing system. The processing system may then transmit, to the counterparty computing system, a second text message comprising at least a portion of the information from the text message history.

The present disclosure relates generally to machine learning, and relates more particularly to methods, non-transitory computer-readable media, and apparatuses for transmitting by a processing system of an endpoint device to a counterparty computing system a text message comprising at least a portion of information from a text message history between the endpoint device and the counterparty computing system.

### BACKGROUND

Texting has gone from early fax machines, to pagers, to T9 inputs on your phone, to emojis and emoticons, and now to Multimedia Messaging Service (MMS) where short videos, audio, and pictures mix effortlessly with a thread of text between users. In addition, Short Message Service (SMS) messages are frequently used as a part of two-factor authentication (2FA) for many applications. However, SMS may be insecure and susceptible to man-in-the-middle attacks or the like.

### SUMMARY

The present disclosure broadly discloses methods, computer-readable media, and apparatuses for transmitting by a processing system of an endpoint device to a counterparty computing system a text message comprising at least a portion of information from a text message history between the endpoint device and the counterparty computing system. For instance, in one example, a processing system including at least one processor of an endpoint device may obtain an authentication request from a counterparty computing system via a first text message, where the authentication request is based on a context associated with at least one of: the endpoint device, a user of the endpoint device, or the counterparty computing system. The processing system may next retrieve contextual content in response to the authentication request, where the contextual content comprises information from a text message history between the endpoint device and the counterparty computing system. The processing system may then transmit, to the counterparty computing system, a second text message comprising at least a portion of the information from the text message history.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure may operate;

FIG. 2 illustrates an example system including a network-based artificial intelligence agent platform, according to the present disclosure;

FIG. 3 illustrates an example use of text-message based contextual authentication, in accordance with the present disclosure;

FIG. 4 illustrates a flowchart of an example method for transmitting by a processing system of an endpoint device to a counterparty computing system a text message comprising at least a portion of information from a text message history between the endpoint device and the counterparty computing system; and

FIG. 5 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and apparatuses for transmitting by a processing system of an endpoint device to a counterparty computing system a text message comprising at least a portion of information from a text message history between the endpoint device and the counterparty computing system. In particular, examples of the present disclosure enable businesses and users alike to authenticate the recipients of text messages in a secure and privacy-protective manner using contextual information associated with the recipient and/or the recipient's endpoint device. To illustrate, endpoint device-based and/or network-based contextual enhancement may enable an entity, such as a financial institution or other users to determine that an interaction is with a same user and/or that a user is behaving in a manner that is within a normal usage pattern of that user. For instance, contextual elements, particularly from a user's conversation history (e.g., a text/SMS history or the like) with another user or entity can be used to authenticate the user, e.g., alone or as an additional authentication factor. Notably, one-time pin messages that may be used for two-factor authentication are a prime target for phone number hijacking. Various high-profile examples exist of malicious actors porting phone numbers without user consent or awareness, and further gaining access to one-time passcode messages to access financial accounts or the like. In contrast, examples of the present disclosure use unique user contexts, particularly conversation history between an entity and a user, for authentication. In one example, a one-time passcode/pin may still be used in connection with the present disclosure. However, if the context returned is unusual in any way, the pin can be invalidated and the user and/or the counterparty may be protected.

As an example of a high-security use case, a financial institution's computing system may share a symmetric key with a user (e.g., a customer), and may check-in with the user over time. In the event of a large event (money transfer, new log-in, etc.), the financial institution may transmit a one-time passcode/pin to the user's endpoint device. In the event that the recipient is the intended user, the user may receive the pin, and may input the pin as directed, e.g., in a log-in webpage form, or the like. In addition, the user's endpoint device may automatically confirm the context of the user (and/or the context of the endpoint device). For example, the endpoint device may confirm that the endpoint device is a same mobile phone that the user has had for more than one year with a same phone number that has been assigned to the user for more than 6 years, that the user/endpoint device is at home based on network location, that the user is on a home Wi-Fi network, that the endpoint device and/or the user still knows the shared secret of the symmetric key, and so forth. If the recipient is not the intended user and/or endpoint device, the recipient and/or the endpoint device may try to fake some of the context, but would not know all of it. As such, the financial institution may, based on the contextual response, determine whether or not to accept the one time pin as a valid authentication factor.

In another example of a mid-security use case, a school may send a notification to a parent about their child. In this case, respective contextual agents of the school's computing system and an endpoint device of a parent might use previous text information or voice call information to check whether the endpoint device has previously contacted any of the school's telephone numbers in the past. In addition, in one example, the contextual agent of the school's computing system may challenge the parent's endpoint device (e.g., the contextual agent thereof) with a query that is based on the prior communication history with the parent and/or the parent's endpoint device. For instance, the contextual agent of the school's computing system may ask: “When was the last time the school contacted you, and what was the communication about?” The contextual agent of the parent's endpoint device may analyze the past communications to extract the answer to the query, e.g., to determine the date and to determine the main purpose(s) of the communication. The endpoint device may then provide a response to the query. For instance, the contextual agent of the parent's endpoint device may create a generative text containing the responsive information. The contextual agent of the school's computing system may then determine whether the answer is acceptable based on its own analysis of the past communications that it sent. By combining the phone number and communication history, the confidence that the notification is sent to the right contact may be increased.

In one example, the present disclosure may enable the exchange of challenge queries and responses between user and counterparty devices/systems, e.g., contextual agents thereof, via text message. More specifically, the present disclosure may provide for separate contextual agent-to-contextual agent communications that are not presented to the user and/or to the counterparty (e.g., if a human and not an automated system). For example, contextual agent-to-contextual agent communication may be provided via a Rich Communication Services (RCS) protocol, or suite. In particular, RCS enables the communication of text, video, voice, etc. in addition to the actual text message content being sent. Notably, RCS was designed so that suggestion answers to text messages could be sent along with the message. This make it easy for a recipient to unlock a message, and then respond with a single tap. These pre-built responses are based solely on the content of the message. A message asking a binary question (e.g., a yes or no question) may provide the possible answers “yes” or “no.” These suggested responses are all based on the content of a text itself, and ignore the context entirely. However, in accordance with the present disclosure, RCS may be used for devices and contextual agents to share additional contextual content, e.g., to pass authentication challenge queries and/to provide generative answers/responses thereto. In this regard, it should be noted that as referred to herein, a text message may comprise a message in a format that is capable of conveying user-to-user or user-to-system text content, but which does not necessarily have to include such text content (e.g., a short message service (SMS) message, a multimedia message service (MMS) message, a RCS message, etc.). For instance, in accordance with the present disclosure, a text message may be used to convey additional contextual content but with a blank/empty text content, i.e., with nothing to display/present to the user of the receiving endpoint device.

In particular, examples of the present disclosure include a contextual agent on the user's endpoint device (e.g., an AI/ML agent, such as a large language model (LLM) agent) that may answer authentication challenge queries based on additional contextual content associated with the user and more specifically the user's relationship with a counterparty in a text-based conversation. In one example, a contextual agent of the present disclosure may include a local language model text editor/composer. For instance, the local language model may be derived from a generative AI-based large language model (LLM) that is further trained on a user's own messages to retrieve contextual content in response to a request (e.g., a challenge query in a first text message), where the contextual content comprises information from a text message history between the endpoint device and the counterparty computing system, and/or to transmit to the counterparty computing system, a second text message comprising at least a portion of the information from the text message history (e.g., responsive to the query). In one example, the contextual agent may access user information on the user's endpoint device and/or from one or more network-based systems to derive the relevant contextual content to answer the challenge queries. In addition, in one example, the counterparty's computing system (e.g., another endpoint device such as a mobile phone or text message capable endpoint device, a text message capable server, etc.) may include a contextual agent that may possess and/or have access to the same contextual information (or information comprising a counterparty's perspective of the contextual information in possession of the user's endpoint device). For instance, the contextual agent of the counterparty's computing system may utilize the relevant contextual information to automatically generate one or more challenge queries to be answered by the contextual agent of the user's endpoint device. In addition, the contextual agent of the counterparty's computing system may determine whether an answer is acceptable based on its own analysis of the past communications that it sent. For instance, the contextual agent of the counterparty's computing system may have a prompt template/input of: “determine whether the following answer “Y” is a correct response to the query “X.” In one example, the prompt/prompt template may further indicate “the following is the relevant text history . . . ” where some or all of the text message history between the parties may be attached.

In one example, the contextual agent of a user's endpoint device may be granted permission by the user to access other applications on the same user endpoint device as the text message application, e.g., to access user data, which may comprise additional contextual content that may be used for several purposes as described herein. In one example, the contextual agent may be granted permission by the user to access user data from one or more network-based services (e.g., user data from a social media service provider, a calendar service provider, an over-the-top messaging service provider, etc.). Thus, the contextual agent may use this user data/additional contextual content to understand what information is relevant to answering a challenge query from a counterparty computing system (e.g., from the contextual agent thereof), and hence what should be included in an outgoing text message. In addition, the generative AI/ML-based model may be provided with additional contextual content, such as the particular relationship between the users, their conversation history, etc., to answer challenge queries. For instance, a prompt to a generative AI/ML-based model may include the query from the counterparty's computing system with an instruction “answer the following query: . . . ” In addition, the prompt may further state “the following is a relevant text message history . . . ” where the text message history between the user and/or the user's endpoint device and the counterparty and/or the counterparty's computing system may be attached as supplemental prompt content.

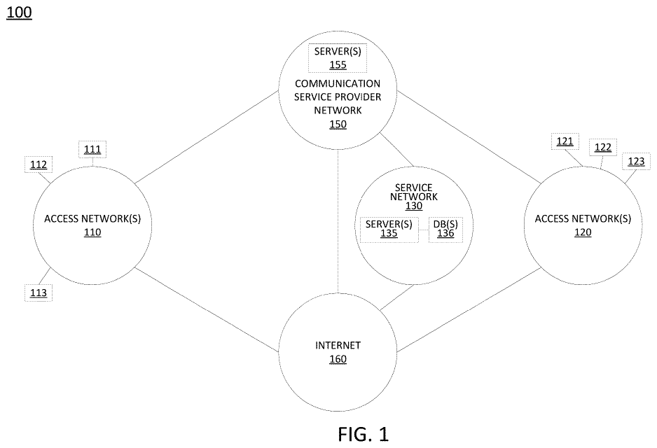

In one example, users may consent or opt-in to the information retrieval process performed by the contextual agent(s), e.g., in the same or similar manner as permissions are granted or revoked for other applications that may be in operation on an endpoint device. In one example, separate messages between contextual agents may be sent that are not for direct consumption by the parties. Accordingly, contextual agents may be integrated with local (on device) and/or cloud-based text message applications (e.g., a device-native SMS/MMS application), email applications, calendar applications, contacts lists, messaging applications (e.g., over-the-top (OTT) messaging applications), and so forth, each with its limits and privacy controls, which the user may define, control, and adjust over time. These and other aspects of the present disclosure are discussed in greater detail below in connection with the examples of FIGS. 1-5.

To aid in understanding the present disclosure, FIG. 1 illustrates an example system 100 comprising a plurality of different networks in which examples of the present disclosure may operate. Communication service provider network 150 may comprise a core network with components for telephone services, Internet services, and/or video services (e.g., triple-play services, etc.) that are provided to customers (broadly “subscribers”), and to peer networks. In one example, communication service provider network 150 may combine core network components of a cellular network with components of a triple-play service network. For example, communication service provider network 150 may functionally comprise a fixed-mobile convergence (FMC) network, e.g., an IP Multimedia Subsystem (IMS) network. In addition, communication service provider network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VOIP) telephony services. Communication service provider network 150 may also further comprise a video broadcast network, e.g., a television broadcast network, such as a cable provider network or an Internet Protocol Television (IPTV) network, as well as an Internet Service Provider (ISP) network. With respect to video service provider functions, communication service provider network 150 may include one or more video servers for the delivery of video content, e.g., a broadcast server, a cable head-end, a video-on-demand (VOD) server, and so forth. For example, communication service provider network 150 may comprise a video super hub office, a video hub office and/or a service office/central office.

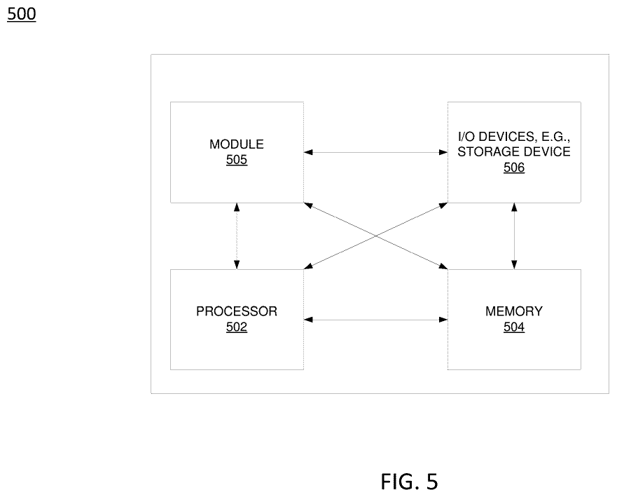

In one example, communication service provider network 150 may also include one or more servers 155. In one example, the servers 155 may each comprise a computing system, such as computing system 500 depicted in FIG. 5, and may be configured to host one or more network-based systems/components in accordance with the present disclosure. For example, a first system component may comprise a database of assigned telephone numbers, a second centralized system component may comprise a database of basic customer account information for all or a portion of the customers/subscribers of the communication service provider network 150, a third centralized system component may comprise a cellular network service home location register (HLR), e.g., with current serving base station information of various subscribers, and so forth. Other system components may include a Simple Network Management Protocol (SNMP) trap, or the like, a billing system, a customer relationship management (CRM) system, a trouble ticket system, an inventory system (IS), an ordering system, an enterprise reporting system (ERS), an account object (AO) database system, and so forth. In addition, other system components may include, for example, a layer 3 router, an SMS server and/or an MMS server, a voicemail server, a video-on-demand server, a server for network traffic analysis, and so forth. It should be noted that in one example, a system component may be hosted on a single server, while in another example, a system component may be hosted on multiple servers, e.g., in a distributed manner. For ease of illustration, various components of communication service provider network 150 are omitted from FIG. 1.

In one example, access networks 110 and 120 may each comprise a Digital Subscriber Line (DSL) network, a broadband cable access network, a Local Area Network (LAN), a cellular or wireless access network, and the like. For example, access networks 110 and 120 may transmit and receive communications between endpoint devices 111-113, endpoint devices 121-123, and service network 130, and between communication service provider network 150 and endpoint devices 111-113 and 121-123 relating to voice telephone calls, communications with web servers via the Internet 160, and so forth. Access networks 110 and 120 may also transmit and receive communications between endpoint devices 111-113, 121-123 and other networks and devices via Internet 160. For example, one or both of the access networks 110 and 120 may comprise an ISP network, such that endpoint devices 111-113 and/or 121-123 may communicate over the Internet 160, without involvement of the communication service provider network 150. Endpoint devices 111-113 and 121-123 may each comprise a telephone, e.g., for analog or digital telephony, a mobile device, such as a cellular smart phone, a laptop, a tablet computer, etc., a router, a gateway, a desktop computer, a plurality or cluster of such devices, a television (TV), e.g., a “smart” TV, a set-top box (STB), and the like. In one example, any one or more of endpoint devices 111-113 and 121-123 may represent one or more user devices and/or one or more servers of one or more service providers, such as a social media service provider, an over-the-top (OTT) messaging application service provider, a navigation service provider, an online calendar/scheduling service provider, and so on. Endpoint devices 111-113 and/or 121-123 may also represent one or more servers of one or more entities that may seek to authenticate a user (e.g., one or more counterparty computing systems). For instance, a counterparty computing system may comprise one or more network-connected servers or other computing resources that may be operated by a financial institution, a governmental agency (such as a department of motor vehicles, a tax collection entity, a tax assessor, etc.), an educational institution, a medical service provider (e.g., a hospital, a physician's office, etc.), an online merchant, a transportation service provider, etc.

In one example, the access networks 110 and 120 may be different types of access networks. In another example, the access networks 110 and 120 may be the same type of access network. In one example, one or more of the access networks 110 and 120 may be operated by the same or a different service provider from a service provider operating the communication service provider network 150. For example, each of the access networks 110 and 120 may comprise an Internet service provider (ISP) network, a cable access network, and so forth. In another example, each of the access networks 110 and 120 may comprise a cellular access network, implementing such technologies as: global system for mobile communication (GSM), e.g., a base station subsystem (BSS), GSM enhanced data rates for global evolution (EDGE) radio access network (GERAN), or a UMTS terrestrial radio access network (UTRAN) network, among others, where communication service provider network 150 may provide service network 130 functions, e.g., of a public land mobile network (PLMN)-universal mobile telecommunications system (UMTS)/General Packet Radio Service (GPRS) core network, or the like. In still another example, access networks 110 and 120 may each comprise a home network or enterprise network, which may include a gateway to receive data associated with different types of media, e.g., television, phone, and Internet, and to separate these communications for the appropriate devices. For example, data communications, e.g., Internet Protocol (IP) based communications may be sent to and received from a router in one of the access networks 110 or 120, which receives data from and sends data to the endpoint devices 111-113 and 121-123, respectively.

In this regard, it should be noted that in some examples, endpoint devices 111-113 and 121-123 may connect to access networks 110 and 120 via one or more intermediate devices, such as a home gateway and router, e.g., where access networks 110 and 120 comprise cellular access networks, ISPs and the like, while in another example, endpoint devices 111-113 and 121-123 may connect directly to access networks 110 and 120, e.g., where access networks 110 and 120 may comprise local area networks (LANs), enterprise networks, and/or home networks, and the like. In one example, endpoint devices 111-113 and 121-123 may each comprise all or a portion of a computing device or system, such as computing system 500, and/or processing system 502 as described in connection with FIG. 5 below, specifically configured to perform various steps, functions, and/or operations for transmitting by a processing system of an endpoint device to a counterparty computing system a text message comprising at least a portion of information from a text message history between the endpoint device and the counterparty computing system, as described herein. For example, any one or more of endpoint devices 111-113 and 121-123 may perform operations in connection with the example method 400, or as otherwise described herein. For instance, any one or more of endpoint devices 111-113 and 121-123 may comprise a contextual agent, e.g., an AI/ML agent as described herein, that may obtain an authentication request from a counterparty computing system via a first text message, where the authentication request is based on a context associated with at least one of: the endpoint device, a user of the endpoint device, or the counterparty computing system, and that may further retrieve contextual content in response to the request, where the contextual content comprises information from a text message history between the endpoint device and the counterparty computing system, and transmit, to the counterparty computing system, a second text message comprising at least a portion of the information from the text message history, and so forth.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure.

In one example, the service network 130 may comprise a local area network (LAN), or a distributed network connected through permanent virtual circuits (PVCs), virtual private networks (VPNs), and the like for providing data and voice communications. In one example, the service network 130 may be associated with the communication service provider network 150. For example, the service network 130 may comprise one or more devices for providing services to subscribers, customers, and/or users. For example, communication service provider network 150 may provide a cloud storage service, web server hosting, and other services. As such, service network 130 may represent aspects of communication service provider network 150 where infrastructure for supporting such services may be deployed. In another example, service network 130 may represent a third-party network, e.g., a network of an entity that provides for AI agent hosting and/or machine learning model platform as a service to various other entities.

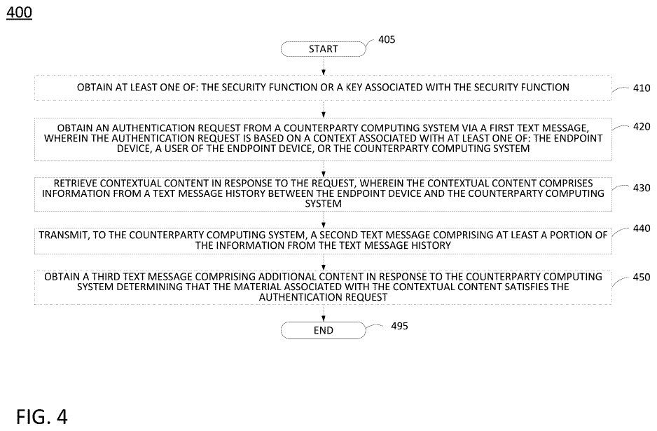

In the example of FIG. 1, service network 130 may include one or more servers 135 which may each comprise all or a portion of a computing device or system, such as computing system 500, and/or processing system 502 as described in connection with FIG. 5 below, specifically configured to perform various steps, functions, and/or operations in connection with examples of the present disclosure for transmitting by a processing system of an endpoint device to a counterparty computing system a text message comprising at least a portion of information from a text message history between the endpoint device and the counterparty computing system. For example, one of the server(s) 135, or a plurality of servers 135 collectively, may perform operations in connection with the example method 400 of FIG. 4, or as otherwise described herein. In one example, the one or more of the servers 135 may comprise a data feature store and/or machine learning model development and hosting platform (e.g., a network-based and/or cloud-based service hosted on the hardware of servers 135).

In one example, service network 130 may also include one or more databases (DBs) 136, e.g., physical storage devices integrated with server(s) 135 (e.g., database servers), attached or coupled to the server(s) 135, and/or in remote communication with server(s) 135 to store various types of information in support of systems for contextual agent-based authentication, as described herein. In one example, server(s) 135 and/or DB(s) 136 may comprise cloud-based and/or distributed data storage and/or processing systems comprising one or more servers at a same location or at different locations. For instance, DB(s) 136, or DB(s) 136 in conjunction with one or more of the servers 135, may represent a distributed file system, e.g., a Hadoop® Distributed File System (HDFS™), or the like.

In one example, DB(s) 136 may be configured to receive and store user data associated with various network-based services, such as text messaging applications (e.g., native SMS/MMS and/or OTT applications), social media applications, calendar applications, map/navigation applications, and so forth. In one example, DB(s) 136 may be configured to receive and store network operational data collected from the communication service provider network 150, such as call logs, mobile device location data, and other information and statistics. Any or all of such data may be compiled and processed, e.g., normalized, transformed, tagged, etc., and forwarded to DB(s) 136 directly or via one or more of the servers 135. For instance, users may have different contact lists from various applications, which may have different formats for each contact record, and which may be normalized to a singular format for storage in DB(s) 136.

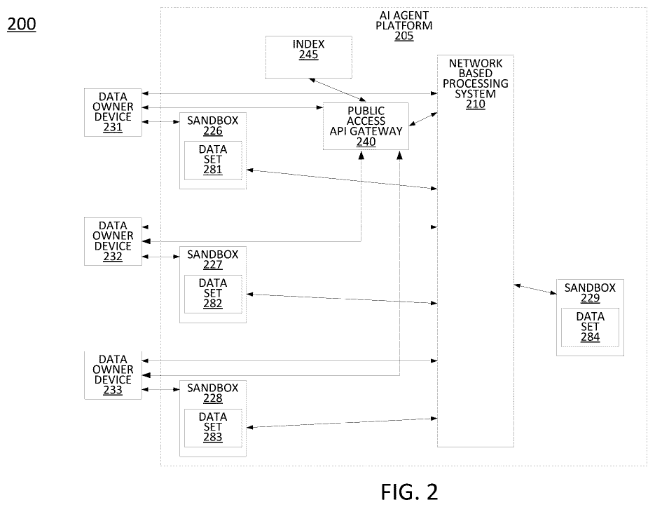

In one example, the user data may include transcripts of various text conversations via SMS/MMS and/or one or more OTT messaging applications, user location data, contact list and contact information, including names, relationship types (e.g., friend, family, colleague, service provider, etc.), and so forth. User data may also include user calendar information (e.g., scheduled calls, meetings, sports, social, and other events, or the like), user status information (e.g., busy/do not disturb, at work, in transit, etc.), user mood information, user biometric information, such as from a smartwatch or other network-connected biometric devices, and so forth. It should be noted that in each case, the data stored by DB(s) 136 may be associated with respective users and may comprise additional contextual content and/or may be used to derive or generate additional contextual content that may be used for various purposes in accordance with the present disclosure, including training machine learning models, for applying as inputs and/or supplemental prompt content to machine learning models, e.g., providing additional contextual content to contextual agents, e.g., AI/ML-based agents, that are deployed and in operation for generating answers to contextual queries, predictions, inferences, or the like. It should be noted that the user data may be segregated and subject to data privacy and security measures such that user data is only utilized in accordance with granted user permissions and only on an as-needed basis to fulfill an authorized task on behalf of the respective user. For instance, server(s) 135 or server(s) 135 in conjunction with DB(s) 136 may comprise an AI agent platform 205 (e.g., a network-based data sharing platform) such as illustrated in FIG. 2 and described in greater detail below. In one example, contextual agents for user endpoint devices may be trained/developed via server(s) 135 (e.g., using contextual information stored in DB(s) 136 as training data) and may then be deployed to respective ones of the endpoint devices 111-113 or 121-123, e.g., associated with respective users.

In an illustrative example, a user of endpoint device 111 may seek to log-in to an online banking system, which may be represented by endpoint device 121. Endpoint device 111 may comprise the user's mobile telephone having a phone number, e.g., an international mobile equipment identity (IMEI). The user may attempt to login to the online banking system via endpoint device 111 itself or via another device, such as the user's personal computer, tablet computing device, etc. In either case, the user may enter a username and password, e.g., via an online form on a webpage of the online banking system. In another example, the user may enter the same credentials on a similar form via an online banking application client on the endpoint device 111 itself. The online banking system, e.g., endpoint device 121 may confirm that the username exists in the system and that the password is correct. In accordance with the present disclosure, upon completion of this step, endpoint device 121 may then seek additional authentication of the user and/or the user's endpoint device 111 using one or more context-based authentication challenge queries.

For instance, in accordance with the present disclosure, each party to a transaction may have a contextual agent. In this case, endpoint device 121 may have a contextual agent in possession of relevant contextual information about the user, and more specifically, the user's past interactions with the online banking system. For instance, endpoint device 121 may comprise a SMS client that may send and receive text messages (e.g., SMS messages, MMS messages, RCS messages, or the like) via an SMS gateway server, which may be represented by server(s) 155 in the example of FIG. 1. As such, the contextual agent of endpoint device 121 may possess a text message history comprising past text message exchanged between endpoint device 111 and endpoint device 121. As such, the contextual agent may generate one or more queries from the text message history for an authentication challenge to the endpoint device 111. For instance, as noted above, the contextual agent may comprise an AI/ML agent, such as a LLM. In accordance with the present disclosure, the contextual agent may be configured to automatically generate the one or more queries in response to a prompt, e.g., an input comprising an instruction such as “generate a query that can be answered from the text message history with number xyz-abc-def.” In one example, the contextual agent may comprise an LLM agent that may first determine that it should retrieve the text message history, and which may then re-prompt an LLM core to generate the query (or queries). In another example, endpoint device 121 may be configured to automatically retrieve the text message history and append the text message history as supplemental prompt content for input to the LLM. In one example, the text message history may be pre-vectorized, e.g., via word2vec, doc2vec, or the like.

In one example, different prompts may be used to bias the contextual agent to be more likely to generate queries of different types. For instance, one prompt may be: “generate a query that can be answered from the text message history with number xyz-abc-def. The query should focus on the metadata of the text message history.” This type of prompt may be more likely to result in a query along the lines of: “What is the average time between messages sent within the last 7 days?” However, another prompt may be: “generate a query that can be answered from the text message history with number xyz-abc-def. The query should focus on the purpose of the interaction.” This type of prompt may be more likely to result in a query along the lines of: “What was the purpose of your second most recent text contact to bank X?” In one example, endpoint device 121 may possess several prompt templates, where the endpoint device 121, e.g., the contextual agent thereof, may rotate and/or randomly select different prompts templates for authentication challenge query generation for different instances of when an authentication challenge query may be warranted. Thus, the endpoint devices to be authenticated, such as endpoint device 111, may not know in advance what type of query will be presented (e.g., related more to metadata, related more to communication contents, etc.).

In any case, after a query is generated, the query may be transmitted to the endpoint device that is to be authenticated, e.g., endpoint device 111. The endpoint device 111 may be configured with its own contextual agent that may receive the query, and that may process the query to determine what information should be used to formulate a response/answer. As noted above, in one example, the query may be in accordance with a Rich Communication Services (RCS) protocol, or suite. For instance, as noted above, RCS enables the communication of text, video, voice, etc. in addition to the actual text message content being sent. Accordingly, in one example, the query may be received as part of a same message that includes a message content for the user. For instance, the endpoint device 121 may begin a new text-based conversation with the user via endpoint device 111 and may allow the conversation to proceed with generalities while additional context-based authentication takes place. However, endpoint device 121 may prevent sensitive transactions from occurring until context-based authentication is complete. In another example, the context request may be a stand-alone message, e.g., that does not include any content for user presentation/display, e.g., in an independent background process. For example, as noted above, this may be in the form of a text message with an empty/blank text content (e.g., without text for user presentation). In one example, the query may include an indicator, e.g., at the beginning of the query within the message content, in a message header or signaling field, or the like, to indicate that the query is not for user presentation, but is only for the contextual agent to answer.

The contextual agent of endpoint device 111 may have access to the text message application and hence the text message history between endpoint device 111 and the online banking system represented by endpoint device 121. In one example, the contextual agent of endpoint device 111 may also be configured via a prompt to answer the query presented. For instance, such a prompt may be: “Answer query X. The relevant text message history is attached.” In another example, the contextual agent may have a core LLM with one or more LLM agents/modules to assist in performing sub-tasks, such as identifying relevant sources of contextual information to answer the query, vectorizing the text message history and/or relevant portions thereof, finding the information that is most pertinent to answering the query, generating a response, and transmitting the response, e.g., via SMS/RCS message back to endpoint device 121.

The contextual agent of endpoint device 121 may receive the response and may process the response to determine if the answer is correct/acceptable given the authentication challenge query. In one example, the contextual agent of endpoint device 121 may first process the query itself using the information in its own possession. For instance, when generating the query, the contextual agent of endpoint device 121 may also take note of the answer (or one or more possible expected or desired answers if the query was not a binary question). In one example, it may first select a desired answer and then generate the query therefrom. In another example, it may process the query in a similar manner as the contextual agent of endpoint device 111, but with the information in possession by endpoint device 121 (where it should be noted that the text message history should be the same for both parties). In this way, the contextual agent of endpoint device 121 may have an expected answer that it may then compare to the actual answer/response received from endpoint device 111. In one example, both the expected answer and the actual answer may be vectorized and compared, e.g., in terms of a distance metric in a feature space, such as a Euclidean distance, a Mahalanobis distance, etc. For instance, the answer/response from endpoint device 111 may be considered to be a correct, valid, and/or acceptable answer when the distance is below a predefined threshold that may be set by the online banking system operator. In another example, the contextual agent of endpoint device 121 may be prompted with another prompt in accordance with a prompt template, such as “is Y a valid answer to the query X? The relevant text message history is attached . . . ,” e.g., where the text message history may be again attached (or in another example, where the contextual agent may be directed as to where the text message history, or a vector database including vectors from the text message history, may be obtained). For instance, in this case, the LLM core of the contextual agent of endpoint device 121 may determine whether the answer is correct, valid, and/or acceptable.

When the answer is accepted, endpoint device 121 may permit the transaction to continue. For instance, if the user attempts a login via endpoint device 111 itself, then endpoint device 111 may be granted access to additional webpages or the like, which may include access to sensitive information and/or which may enable the user to initiate sensitive transactions, such as fund transfers, etc. Similarly, if the user seeks to access the online banking system via another device, such as endpoint device 112, then the access may be granted by endpoint device 121 to endpoint device 112. In another example, when the answer is accepted, a one-time passcode may be sent to endpoint device 111, e.g., via text message, where the user may view the passcode and may enter it via the appropriate interface on the device via which the user is seeking to access the online banking system. However, in one example, the context-based authentication of the present disclosure may be used independently from the one-time passcode. For instance, a username/password combination and successful context-based authentication may be sufficient to grant access/permission for some purposes.

It should be noted that the foregoing is just one example of a counterparty (e.g., an online banking system) authenticating a user and/or the user's endpoint device, and that other, further, and different examples may incorporate various alternative or additional aspects of the present disclosure as described herein. For instance, in one example, more than one query and answer/response may be used to authenticate a user/endpoint device, e.g., from a same source and/or one or more different sources of contextual information. In another example, the verification may be performed by the contextual agent of endpoint device 121, where the online banking system to which access is granted may be represented by endpoint device 122. In other words, the contextual agent and context-based verification may be a separate computing system/platform from the portion of the online banking system through which the user may perform various banking tasks, such as checking balances, initiating fund transfers, changing account mailing address, etc.

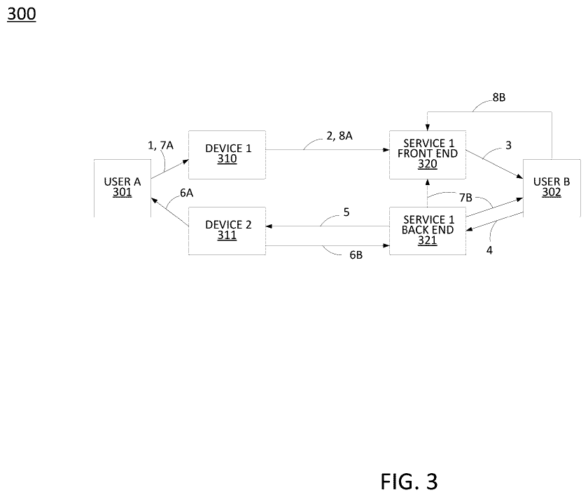

It should again be noted that text-message based contextual authentication of the present disclosure may be used in connection with authorizing a login via another mechanism (e.g., via a website, application (app), or the like), such as illustrated and described in connection with the example of FIG. 3), or to confirm a text-message conversation itself. Similarly, in another example, text-message based contextual authentication of the present disclosure may be used to confirm a voice conversation that is occurring via a user endpoint device. For instance, SMS/RCS-based contextual authenticate messaging may proceed between a counterparty computing system and the user's endpoint device in the background, e.g., while the user engages in voice/phone conversation with a representative of an organization/entity, with an interactive voice response (IVR) system and/or an AI chatbot, or the like. In this regard, it should also be noted that examples of the present disclosure may similarly be used for individuals to authenticate other individuals with whom they may be engaging in text and/or voice conversations. For instance, in the example described above with respect to endpoint devices 111 and 121, the endpoint device 121 may instead represent another individual who is seeking to confirm that the endpoint device 111 and/or the user thereof is a same endpoint device involved in one or more past transactions (e.g., voice or text, etc.). For example, two individuals may have met at a conference and may seek to reconnect to collaborate at a later time, where either or both parties may desire to obtain additional assurance that the other party is who the other party purports to be.

It should also be noted that in the foregoing example, a text message history is used as the relevant user context from which to extract a context-based authentication challenge query and the answer(s). However, in another example, additional context may be used, such as shared images or documents that may be in the possession of both parties (e.g., a draft contract that the parties are working on, a past billing/account statement in portable document format (PDF) or the like, a picture including two new acquaintances at an industry conference, etc.) and/or external data such as content/postings via a social media platform involving one or both parties, and so forth. In this regard, in one example, a user may grant a counterparty permission to access certain information that may be in the possession of a trusted-third party, such as a social media service provider system, a communication network operator network and so forth. For instance, in one example, as noted above, server(s) 135 may store various user data (e.g., contextual information) that may be used for additional context-based authentication as described herein. Alternatively, or in addition, one or more of the endpoint devices 111-113 and/or 121-123 may represent a social media service provider system, or the like, from which additional contextual information may be obtained by one or both of the parties. In other words, the counterparty seeking to authenticate a user endpoint device may use any one or more of these types of contextual information for generating queries and for determining whether correct, valid, and/or acceptable responses/answers are received, e.g., as an alternative or in addition to using the text message history.

In addition, it should be realized that the system 100 may be implemented in a different form than that illustrated in FIG. 1, or may be expanded by including additional endpoint devices, access networks, network elements, application servers, etc. without altering the scope of the present disclosure. As just one example, any one or more of server(s) 135 and DB(s) 136 may be distributed at different locations, such as in or connected to access networks 110 and 120, in another service network connected to Internet 160 (e.g., a cloud computing provider), in communication service provider network 150, and so forth. Thus, these and other modifications are all contemplated within the scope of the present disclosure.

FIG. 2 illustrates an example system 200 including an AI agent platform 205 (e.g., a network-based AI-agent development platform). In one example, the AI agent platform 205 may comprise a processing system, e.g., a server or multiple servers collectively configured to perform various steps, functions, and/or operations in accordance with the present disclosure. In one example, the AI agent platform 205 includes a network-based processing system 210, e.g., a server or multiple servers collectively configured to perform various steps, functions, and/or operations in accordance with the present disclosure. In one example, AI agent platform 205 may be represented by server(s) 135 and/or DB(s) 136 in FIG. 1, or vice versa. In one example, the network-based processing system may comprise all or a portion of a computing device or system, such as computing system 500, and/or processing system 502 as described in connection with FIG. 5 below, specifically configured to perform various steps, functions, and/or operations in accordance with the present disclosure. It should also be noted that the components of network-based processing system 210 and the AI agent platform 205 may comprise various combinations of computing resources (e.g., processor(s), memory unit(s), and/or storage unit(s)) on the same or different host devices, at the same or different locations (e.g., in the same or different data centers). For example, processors assigned to execute instruction sets for different components may be separate from the associated memory resources, which may be separate from associated storage resources where data sets or other data are stored, and so on.

As further illustrated in FIG. 2, the AI agent platform 205 includes a plurality of sandboxes 226-229 (e.g., “private sandboxes’) and a public access application programming interface (API) gateway 240. In various examples, sandboxes 226-229, the data sets 281-284 stored in the different sandboxes 226-229, and/or the public access API gateway 240 may comprise virtual machines, application containers, or the like operating on one or more host devices. In addition, each of sandboxes 226-229, the data sets 281-284 stored in the different sandboxes 226-229, and/or the public access API gateway 240 may comprise various combinations of computing resources, e.g., processor(s), memory unit(s), and/or storage unit(s) on one or more shared host devices and/or on separate host devices. Each of the data sets 281-284 may take a variety of different forms. However, for illustrative purposes, data sets 281-284 may be considered to each include respective user data such as described above, e.g., text message conversations/transcripts, calendar information, user status information, user biometric information, and so forth. In addition, at least some of the user data may comprise restricted data features, e.g., available only for limited use by other entities via the AI agent platform 205, as described herein. In addition, for illustrative purposes, the AI agent platform 205 may comprise a relational database system (RDBS). However, in other, further, and different examples, AI agent platform 205 may comprise a different type of database system, such as a hierarchical database system, a graph-based database system, etc.

In one example, any one or more of the sandboxes 226-228 may be hosted on a shared infrastructure within the network-based processing system 210 (e.g., where a trusted entity controls and operates the data sharing platform, but where the data owners (e.g., respective users) have independent control and access of the respective sandboxes 226-228 and the data sets 281-283 stored therein). For instance, a provider of an AI/ML-based agent development service via the AI agent platform 205 may also securely and separately store data sets 281-283 in sandboxes 226-228 on behalf of the respective users. Thus, AI agent platform 205 may provide services to a number of different users, and may interact with a number of user devices, such as data owner devices 231-233. Each of the user devices may comprise a desktop computer, a cellular smart phone, a laptop, a tablet computer, a cloud based processing system providing a user environment, and so forth. In particular, AI agent platform 205 may be operated by a trusted party to store data sets on behalf of data owners in a secure and restricted manner, to provide for the use of restricted data features, e.g., for training of AI agents, e.g., contextual agents, via the AI agent platform 205 and for providing additional contextual information to contextual agents in operation in accordance with authorizations from users, and so on.

To illustrate, sandbox 226 may store data set 281 for a first data owner/user, which may comprise network operational data collected from a communication service provider network, such as call logs, mobile device location data, call detail records (CDRs), text message history/transcripts, etc., calendar information, biometric information, social media information, contact list(s), and other information and statistics. The data set 281 may include raw data and/or may include data that have been normalized, transformed, tagged, etc. before uploading to the AI agent platform 205. In one example, the data in data set 281 may be uploaded via data owner device 231 and stored in sandbox 226. Alternatively, or in addition, the AI agent platform 205 may be configured to obtain and/or receive the data comprising data set 281 directly from a communication network infrastructure (not shown). The sandbox 226 may represent a secure data storage and data processing environment that is only accessible to the first user (or another person or entity authorized on behalf of the first user) and to the network-based processing system 210. Similarly, sandbox 227 may store data set 282 for a second data owner/user, which may comprise the same or similar types of user data as described above, and likewise for sandboxes 228 and 229 storing data sets 283 and 284, respectively.

Alternatively, or in addition, a sandbox may be associated with a network-based service provider, such as a social media service provider, an OTT messaging application service provider, a calendar application service provider, etc. In such case, user data of a single user may be spread over multiple sandboxes of respective network-based service providers of which a user may obtain services. For instance, in another example, data set 283 in sandbox 228 may comprise user data associated with a social media service, such as user contact data, transcripts/records of text-based communications via the social media service, etc. As in the preceding example(s), the data set 283 may include raw data and/or may include data that have been normalized, transformed, tagged, and/or anonymized, etc. before uploading to the AI agent platform 205. To further illustrate, user data, such as text message conversation transcripts, contact lists, schedules, biometric data, etc., may be ingested by network-based processing system 210 and chunked/segmented, from which vectors/vector embeddings may be generated, such as using word2vec and/or doc2vec, and so forth. These vectors may then be stored in the associated data sets 281-284. In one example, contextual information/user data (or vectors associated with additional contextual content) may be retrieved in accordance with a prompt and/or a contextual vector search.

In addition, it should be further noted that the sandbox 228 may represent another secure data storage and data processing environment that is only accessible to the second data owner (or another person or entity authorized on behalf of the second data owner) and to the network-based processing system 210. In another example, AI agent platform 205 may comprise a feature store in which network-based service providers may contribute respective data sets that are securely stored in a segregated manner, e.g., in separate sandboxes 226-228 with different encryption keys, different access codes/password protection, etc., and where user data of a particular user may be requested from the respective sandboxes 226-228 only for limited use in connection with contextual agent training and/or operations as described herein. For instance, sandbox 229 may be instantiated and assigned to a user and may be populated with various user data, e.g., from one or more of the sandboxes 226-228 that may be associated with different service providers (e.g., a social media service provider, an OTT messaging application service provider, etc.). After a defined period of time, such as 2 hours, 24 hours, 2 weeks, 6 months, etc., or when the user data is no longer considered relevant to a current context of the user and/or a conversation of the user, the user data from other sandboxes may be deleted from sandbox 229.

In one example, the AI agent platform 205 may provide access to an index 245, e.g., via public access API gateway 240. The index 245 may include information about which data sets 281-283 and/or sandboxes 226-228 are associated with respective users or other data owners. In an example in which AI agent platform 205 supports restricted and non-restricted data features, the index 245 may also identify for each data set and for each data feature whether the data feature is restricted or not. For instance, a data feature may be provided with different access/permission levels. For example, a user may designate an endpoint device and/or a contextual agent for having unrestricted access to a data feature, while the data feature may remain “restricted” for access/use by one or more counterparties for user/endpoint device authentication. Likewise, data features may have different restrictions or permission levels for use in contextual agent training.

In one example, sandboxes 226-229 may also store contextual agents, e.g., local language models that may be deployed to respective user endpoint devices as described herein. For instance, a sandbox 229 may be instantiated for a user and may be populated with various user data. In addition, a contextual agent may be created from a template (e.g., a machine learning algorithm with various pre-set or user-selected hyperparameters) that is available via an MLM catalog/repository of the AI agent platform 205. In one example, development of the contextual agent may be provided via sandbox 229, such as hyperparameter selection, training of the AI agent via the data owner's own data features, etc.

It should be noted that as referred to herein, a machine learning model (MLM) (or machine learning-based model), may broadly include models for prediction, classification, forecasting, and/or detection, and may comprise a machine learning algorithm (MLA) that has been “trained” or configured in accordance with input data (e.g., training data) to perform a particular service, e.g., to respond to prompts/queries and/or to otherwise generate text outputs in response to prompts, to forecast weather, to classify images, to predict user arrival times, and so forth. Examples of the present disclosure may incorporate various types of MLAs/models that utilize training data, such as support vector machines (SVMs), e.g., linear or non-linear binary classifiers, multi-class classifiers, deep learning algorithms/models, such as deep learning neural networks or deep neural networks (DNNs), generative adversarial networks (GANs), decision tree algorithms/models, k-nearest neighbor (KNN) clustering algorithms/models, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. In one example, MLAs/MLMs of the present disclosure may be in accordance with an open source library, such as OpenCV, which may be further enhanced with domain specific training data.

In one example, a contextual agent (also referred to herein as an AI/ML agent or ML-based agent) may comprise an ML-based generative model, such as a language model, e.g., a “large language model” (LLM). For instance, the ML-based generative model may comprise a generative adversarial network (GAN), a bidirectional encoder representations from transformers (BERT) model (e.g., BERT-Base, BERT-Large, etc.), a generative pre-training (GPT) model (e.g. GPT, GPT-2, GPT-3, or the like), or other generative natural language processing (NLP) models. In one example, a generative model of the present disclosure may be used in conjunction with engineered prompts, e.g., in which an instruction to generate a query or a query to be answered is embedded within the prompt and/or provided along with the prompt. Similarly, in one example, additional contextual information (e.g., contextual source information, such as text message history, a call history, a social media history, etc.) may be embedded within the prompt, provided along with the prompt, and/or retrieved based upon the content of the prompt. Alternatively, or in addition, examples of the present disclosure may supplement the prompts and capabilities of the generative model using retrieval augmented generation (RAG). For instance, user data (e.g., additional contextual information) may be ingested, vectorized, and added to data set(s) 281-284, where such information may be retrieved in connection with a contextual agent processing a particular prompt and/or a query contained within a prompt.

For instance, a contextual agent of a user's endpoint device may receive a query and may determine one or more data sources relevant to the query (e.g., where network-based processing system 210 may possesses some or all of such information in one or more of sandboxes 226-229 that may be in operation on the network-based processing system 210). Accordingly, the contextual agent of a user's endpoint device may submit a search, and the network-based processing system 210 may perform the search over the vectors in a respective data set based upon the prompt, e.g., a semantic search. For instance, the search may be similarly vectorized and the vectors/vector embeddings of the prompt may be compared to vectors in a respective one of the data sets 281-284 to find the closest matching vectors, e.g., via a distance measure in a hyper-dimensional feature space. The search may comprise the query along with a prompt to find the closest matching data/vectors, or may comprise a new instruction for the network-based processing system 210 to optimize the search. In any case, the search request may be vectorized and a respective one of data sets 281-284 may be scanned to find the closest matching vectors, which may be returned to the contextual agent of the user's endpoint device. In one example, the identified vectors may be further joined with the original query to create an enhanced prompt comprising an input, or input data set for the contextual agent, e.g., for an ML-based generative model, such as a LLM core thereof. In other words, then enhanced prompt may then comprise an input to the ML-based generative model (e.g., an LLM), which may then generate an output comprising an answer to the query.

Alternatively, or in addition, a contextual agent of the present disclosure may include a different configuration or architecture. For example, a contextual agent of the present disclosure may include an intent-determining component to learn intents, and an action-selection component to select actions (e.g., to generate a response/output, to transmit the response/answer to a counterparty computing system via text/RCS message, etc.). In one example, the intent-determining component may comprise a natural language understanding (NLU) module, which may be a trained MLM comprising an SVM, a DNN, such as an RNN, an LSTM model, etc., and so forth. In accordance with the present disclosure, the intent may be that the query demands an answer and/or that certain contextual information is/are needed to formulate an answer. It should be noted that still other architectures and configurations may be used in accordance with the present disclosure. In addition, an AI agent of the present disclosure may include other, further, and different components, such as a translation module (e.g., to translate between different languages that may be used by respective users/participants in a text-based conversation), a speech-to-text and/or text-to-speech component, e.g., for dictation and/or hands-free message retrieval, a feedback and/or reinforcement learning (RL) component (e.g., to learn from feedback regarding whether an answer was acceptable to the counterparty computing system or not), and so forth.

In one example, a contextual agent of the present disclosure may be personalized to a user. For instance, an LLM may be trained on a corpus of training data that includes a substantial component of user-specific content (e.g., in addition to general-knowledge content), including outgoing and incoming text messages of the user, transcribed audio of the user, other writings of the user, such as articles, blogs, social media posts, etc. In another example, a contextual agent of the present disclosure may implement a language model that is trained on a general knowledge base (e.g., GPT-4, BERT-large, etc.) and that is supplemented with user-specific knowledge/context and/or persona-specific knowledge context. For instance, the present disclosure may supplement a prompt with an information set comprising prior communications of a user (and/or vectors generated therefrom as described above). In one example, using personas (e.g., different contextual agents to interact with different counterparties) may prevent a counterparty from using an authentication prompt to obtain information about a user that is not necessary for the counterparty to know. For instance, an online merchant may have a legitimate interest in preventing fraud, but may have no need to know how much money a user spent on their last vacation. Thus, in one example, authentication queries may be limited to context from prior interactions of the user and the online merchant, or other categories that the user has explicitly authorized for use in authentication with the merchant. Conversely, topics/aspects of the user's personal life (context) that are not authorized or that are otherwise not relevant may be excluded.

It should also be noted that in an additional example of the present disclosure, a contextual agent may be network-based/network-deployed. For instance, the AI agent platform 205 may be included in a communication path for text message exchange between users'/participants' devices, and may process text message content via a respective contextual agent that may be instantiated by the AI agent platform 205. In one example, multiple contextual agents may run in respective sandboxes 226-229, or the like, and may ingest text message content and may output revised text message content for onward transmission to a recipient's device and/or a network-based contextual agent thereof (which may also be in operation on the contextual agent platform 205). Thus, these and other modification are all contemplated within the scope of the present disclosure.

To further aid in understanding the present disclosure FIG. 3 illustrates an example 300 of a use of text-message based contextual authentication, in accordance with the present disclosure. In particular, the example of FIG. 3 illustrates a user A (301) utilizing device 1 (310) (e.g., a public-facing computer) at stage 1 to log into service 1 (e.g., service 1 front end (320) at stage 2. At stage 3, service 1 front end (320) may authenticate with user B (302), which may comprise another individual or which may represent an institutional computing system, such as financial institution, etc. In this example, user B (302) may request, at stage 4, that the service 1 backend (321) send a two-factor authentication (2FA) request to user A (301), which may include a PIN/one-time passcode. In on example, user B (302) may also provide a context request and/or context data from which service 1 back end (320) may send a context request to user A and/or to device 2 (311) (e.g., a mobile/cellular telephone) of user A (301). In one example, at stage 5 the PIN/passcode and the context request may be included in a same text message. In another example, the context request may be sent as a separate text message (e.g., with an empty/blank text content with nothing to display/present to user A).

At this point, the communication path may split. In a first path, path A (e.g., stages 6A, 7A, 8A), device 2 (311) may share the one time PIN/passcode with user A (301) (stage 6A). At stage 7A, user A (301) may enter the PIN into device 1 (310). At stage 8A, device 1 (310) may submit the PIN to the service 1 front end (320). In a second path, path B (e.g., stages 6B, 7B, 8B), the device 2 (311) may first respond to the context request to service 1 backend (321) (stage 6B). At stage 7B, the service 1 backend (321) may share the context response with user B or may confirm the validity of the context response directly to service 1 front end (320). Optionally, at stage 8B, user B (302) may confirm the authentication of user A (301) to service 1 front end (320).

FIG. 4 illustrates a flowchart of an example method 400 for transmitting by a processing system of an endpoint device to a counterparty computing system a text message comprising at least a portion of information from a text message history between the endpoint device and the counterparty computing system, in accordance with the present disclosure. In one example, steps, functions, and/or operations of the method 400 may be performed by a device or apparatus as illustrated in FIG. 1, e.g., one of the endpoint devices 112-113 or 121-123. Alternatively, or in addition, the steps, functions and/or operations of the method 400 may be performed by a processing system collectively comprising a plurality of devices as illustrated in FIG. 1 such as one of the endpoint devices 111-113 and/or 121-123 in conjunction with server(s) 135 and/or a device/processing system as illustrated in FIG. 2, such as network-based processing system 210, AI agent platform 205, data owner devices 231-233, and so forth. In one example, the steps, functions, or operations of method 400 may be performed by a computing device or system 500, and/or a processing system 502 as described in connection with FIG. 5 below. For instance, the computing device 500 may represent at least a portion of a platform, a server, a system, an endpoint device, and so forth in accordance with the present disclosure. For illustrative purposes, the method 400 is described in greater detail below in connection with an example performed by a processing system. The method 400 begins in step 405 and may proceed to optional step 410 or to step 420.

At optional step 410, the processing system, e.g., of a user endpoint device, may obtain at least one of: a security function or a key associated with the security function, e.g., from a counterparty computing system or from a third party that may manage keys for one or both transaction parties. For example, the security function and/or key may be for use in the application of an input vector comprising contextual information (e.g., text message history data from a text message history, etc.) to the security function to obtain an output that may be used as a response to an authentication challenge query.

At step 420, the processing system obtains an authentication request from a counterparty computing system via a first text message, where the authentication request is based on a context associated with at least one of: the endpoint device, a user of the endpoint device, or the counterparty computing system. For instance, the authentication request may comprise a query having a correct, valid, and/or acceptable answer that can be obtained from the context associated with the at least one of: the endpoint device, the user of the endpoint device, or the counterparty computing system. In one example, the first text message may be in accordance with a Rich Communication Services (RCS) protocol, or suite, e.g., the first text message may comprise a RCS message. In one example, text message content (e.g., for presentation to the user) may be optional, and the first text message may be exclusively for use by an AI agent/contextual agent of the endpoint device to authenticate to the counterparty.

At step 430, the processing system retrieves contextual content in response to the request, where the contextual content comprises information from a text message history between the endpoint device and the counterparty computing system. For instance, the information from the text message history may comprise a text message content of one or more text messages of the text message history. Alternatively, or in addition, the information from the text message history may comprise metadata of the one or more text messages of the text message history. To further illustrate, the metadata may comprise one or more of: timing information of the one or more text messages (e.g., the sent and/or received time(s) of the one or more messages, the read time(s) of the one or more messages, the timing between two messages of the one or more messages, and/or an average time between messages within a time window, etc.), length information of the one or more text messages (e.g., a number of words, characters, lines, etc.), data size information of the one or more text messages, and so forth. In still another example, the information from the text message history may comprise an output of a security function in response to an input vector comprising text message history data from the text message history. For instance, the information from the text message history may comprise a hash and/or encryption of the text message content using a hash key and/or encryption key that is previously shared (e.g., in accordance with optional step 310). In such an example, the text message history data may still comprise a text message content of one or more text messages of the text message history or metadata of the one or more text messages of the text message history. However, the retrieval of the contextual content at step 430 may include applying the input vector to the security function implemented by the processing system (such as a one-way hash function, or the like) to obtain the output. In one example, the text message history may also comprise a sequence of RCS messages, e.g., where some messages may be for presentation to the user, while others may be for handling by the AI agent/contextual agent on the endpoint device (e.g., behind the scenes without presentation and/or notification to the user, such as for previous context-based authentication interactions via text/RCS messages).

As noted above, the contextual content may include additional data beyond that which may be extracted from a text message history. For example, the contextual content may further include: location information of the endpoint device and/or media file data accessible to the endpoint device (e.g., images, video or audio clips, documents, or other files). In such example(s), the contextual content may include the contents of the media file(s) and/or metadata of the media file(s), such as size, created date, file format, author, focal length, location captured, etc., depending on the type(s) of media file(s) and the particular metadata fields available and/or for which the metadata fields are populated with useable information. In one example, the contextual content may be stored at the endpoint device. In one example, the contextual content may alternatively or additionally include information obtained from an application of the endpoint device (e.g., that is not the native text message app/function, such as a social media application, etc.). For example, two users may be part of a same closed social media community, where the context may come from content/activity within the community space. In this regard, the contextual content does not need to be communications directly between user A and user B, but could be something posted by a different user in a community to which the user and the counterparty both belong, e.g., from user C. In still another example, the contextual content may further comprise information that is accessed by the endpoint device from a network-based system, e.g., from the carrier communication network/cellular network, such as server(s) 135/DB(s) 136 in FIG. 1, the AI agent platform 205 of FIG. 2, or the like, and/or from server(s) of a social media service provider, an OTT messaging application service provider, etc.

In one example, the contextual content may be selected via an AI agent implemented by the processing system, e.g., a contextual agent. For instance, the AI agent may comprise a machine learning-based language model, e.g., a LLM, such as a GAN model, a BERT model, a GPT model, or other LLM, and so forth. In one example, the identifying of the contextual content may include a retrieval augmented generation (RAG) process. For example, the text message history and/or other contextual information (such as location, etc.) may be input to the MLM as supplemental prompt content. In addition, in one example, the AI agent may comprise a LLM agent, e.g., a system with a LLM core and one or more LLM agents/modules for performing and/or assisting in various sub-tasks, such as a module with application programming interfaces (APIs), webhooks, or the like to obtain contextual content from one or more data sources, a module to invoke a text messages/RCS application to transmit a message including the response at the following step 340, and so forth. To further illustrate, an LLM agent in accordance with the present disclosure may include a module that may take a high level approach of identifying any sources outside of the text message history that may be relevant to responding to the authentication request, and may pull data from those sources for supplemental prompt content, such as location history, social media usage history, etc. In one example, this may be another MLM, e.g., an LLM or another model that is trained/configured to interpret the authentication request/query and to map the authentication request to the one or more relevant data sources. In one example, step 430 may include the processing system performing a semantic search by vectorizing the text message content and/or a conversation history (e.g., within a defined look-back window, or other time periods or number of messages) and then comparing the vectors/vector embeddings to vectors associated with various endpoint device-based and/or network-based user data to find the closest matching vectors.

At step 440, the processing system transmits, to the counterparty computing system, a second text message comprising at least a portion of the information from the text message history. For instance, the material associated with the contextual content that is retrieved may comprise a response to the authentication request, which could be an answer to a query (e.g., in a natural language/text format), a solution to a challenge/problem that is based on the contextual content that is retrieved, and/or the contextual content itself. For instance, in one example, the material associated with the contextual content that is retrieved may comprise a generative text response to the authentication request that is based on the contextual content that is retrieved. In one example, the second text message may also comprise an RCS message.

At optional step 450, the processing system may obtain a third text message comprising additional content in response to the counterparty computing system determining that the material associated with the contextual content satisfies the authentication request. For instance, as noted above, the counterparty computing system may include another contextual agent that may determine whether the answer to the query is a correct and/or satisfactory answer. For instance, in one example, the response can be in a natural language format and more than one formulation of the response may be used, while still being semantically correct (e.g., “the last time we messaged was on Nov. 1, 2024” or “Nov. 1, 2024 was the last day we messaged,” which convey the same meaning). Upon acceptance of the answer, the text conversation may be permitted to proceed, the user may be permitted to engage in sensitive banking transactions via the endpoint device or another device, and so forth. In one example, the third text message may include a one-time passcode that may be used for further authentication via the endpoint device or another device via which a log-in is being attempted, for instance.

Following step 440 or optional step 450, the method 400 proceeds to step 495 where the method 400 ends.

It should be noted that the method 400 may be expanded to include additional steps, or may be modified to replace steps with different steps, to combine steps, to omit steps, to perform steps in a different order, and so forth. For instance, in one example the processing system may repeat one or more steps of the method 400, such as steps 420-440, steps 410-440, steps 420-450, etc, for subsequent authentication requests from a same or a different counterparty. In one example, the method 400 may include training the AI agent/contextual agent and/or one or more generative ML-based models thereof. In addition, although the foregoing is described primarily in connection with text/RCS messages, in various examples, the text messages may comprise SMS or MMS messages, messages in accordance with Message Session Relay Protocol (MSRP), e.g., RCS or the like, messages via an OTT messaging application, etc. For instance, in one example, the present disclosure may add an Internet Protocol (IP) address into a text message header (e.g., a Short Message Service (SMS) and/or Multimedia Message Service (MMS) header). Using these IP addresses, AI agents may establish and/or maintain sessions for exchange of additional contextual content. In addition, such exchange of additional contextual content may continue online, even when respective endpoint devices and/or counterparty computing systems are not connected to a mobility network. In particular, a mobile smart phone is typically assigned an IP address (e.g., at least one IP address) for its data streams. Appending such an IP address into the header of a text message may enable the recipient's endpoint device to then send data directly to the sender's endpoint device over any network connection. Alternatively, or in addition, an IP address included in a text message header may be used to route device-to-device specific messages to IP-interfaced servers where additional contextual content may be obtained. Thus the text messages may still be processed via the SMS/MMS infrastructure in existing network architectures. In one example, an additional header field may be used to alert the network and receiving device to the fact that a message is requesting and/or conveying additional contextual authentication related information, e.g., a query/request, a response/answer, etc.

As noted above, in one example, the contextual content may further comprise information that is accessed by the endpoint device from a network-based system, e.g., from the carrier communication network/cellular network. For instance, the contextual content may include a movement history of the device, e.g., within the last 5 minutes, the last day, the last week, etc. The endpoint device may assert the location history to the counterparty computing system. In addition, the endpoint device may provide therewith or may provide in response to a challenge from the counterparty computing system further assertion from the communication network of the endpoint device location history. In one example, the endpoint device may encrypt and/or hash the location information stored on the endpoint device with a first key provided by the counterparty computing system. The endpoint device may further request the location history from the communication network and may provide the first encryption key to the communication network. The communication network may provide the requested information back to the endpoint device, but in an encrypted format using the first key and then using a second key selected by the network. The endpoint device can provide the double-encrypted contents to the counterparty computing system in the same encrypted format, e.g., at step 440 or independently. In one example, the communication network may also provide to the counterparty computing system the second encryption key. Accordingly, the counterparty computing system can use the second encryption key to partially decrypt. This should then match the first information provided from the endpoint device from its own location records. Notably, in one example, the first key may not be useable to decrypt, but may comprise a one-way hash. Thus, the counterparty computing system can verify that the data asserted by the endpoint device matches the data asserted by the communication network, but without the communication network providing the data in an accessible format to the counterparty computing system. This can also work for other types of data, such as date(s) of last bill(s) paid to communication network operator, or call history with other entities (e.g., a full call history of the last week, etc.).

In addition, in one example, the method 400 may further include the processing system/endpoint device volunteering to use N number of data points with network verification. In another example, the counterparty computing system may specify the number and/or the types of information to be used. In one example, the communication network may include an API to indicate to counterparty computing systems the types of data available. In one example, the method 400 may include the processing system generating an authentication request for the counterparty using the same or different contextual information, transmitting the request to the counterparty, obtaining an answer/response, verifying the correctness/acceptability of the response as described above, and so forth. For example, both parties may seek additional contextual verification of the other. In still another example, a method may include the counterparty computing system performing steps, functions, and/or operations that are complementary to the steps, functions, and/or operations of the example method 400. For instance, such a method may include generating the authentication request using the context (e.g., contextual content available to the counterparty computing system), transmitting the request to the endpoint device, obtaining the response, verifying the response, allowing access and/or transmitting additional data (e.g., sensitive data) upon verification of the correctness/acceptability of the response, and so forth. In one example, the method 400 may be expanded or modified to include steps, functions, and/or operations, or other features described above in connection with the example(s) of FIGS. 1-3, or as described elsewhere herein. Thus, these and other modifications are all contemplated within the scope of the present disclosure.

In addition, although not expressly specified above, one or more steps of the method 400 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 4 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the example embodiments of the present disclosure.

FIG. 5 depicts a high-level block diagram of a computing system 500 (e.g., a computing device or processing system) specifically programmed to perform the functions described herein. For example, any one or more components, devices, and/or systems illustrated in FIGS. 1-3, or described in connection with FIG. 4 may be implemented as the computing system 500. As depicted in FIG. 5, the computing system 500 comprises a hardware processor element 502 (e.g., comprising one or more hardware processors, which may include one or more microprocessor(s), one or more central processing units (CPUs), and/or the like, where the hardware processor element 502 may also represent one example of a “processing system” as referred to herein), a memory 504, (e.g., random access memory (RAM), read only memory (ROM), a disk drive, an optical drive, a magnetic drive, and/or a Universal Serial Bus (USB) drive), a module 505 for transmitting by a processing system of an endpoint device to a counterparty computing system a text message comprising at least a portion of information from a text message history between the endpoint device and the counterparty computing system, and various input/output devices 506, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 502 is shown, the computing system 500 may employ a plurality of hardware processor elements. Furthermore, although only one computing device is shown in FIG. 5, if the method(s) as discussed above is implemented in a distributed or parallel manner for a particular illustrative example, e.g., the steps of the above method(s) or the entire method(s) are implemented across multiple or parallel computing devices, then the computing system 500 of FIG. 5 may represent each of those multiple or parallel computing devices. Furthermore, one or more hardware processor elements (e.g., hardware processor element 502) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 502 can also be configured or programmed to cause other devices to perform one or more operations as discussed above. In other words, the hardware processor element 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the present module 505 for transmitting by a processing system of an endpoint device to a counterparty computing system a text message comprising at least a portion of information from a text message history between the endpoint device and the counterparty computing system (e.g., a software program comprising computer-executable instructions) can be loaded into memory 504 and executed by hardware processor element 502 to implement the steps, functions or operations as discussed above in connection with the example method(s). Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The processor (e.g., hardware processor element 502) executing the computer-readable instructions relating to the above described method(s) can be perceived as a programmed processor or a specialized processor. As such, the present module 505 for transmitting by a processing system of an endpoint device to a counterparty computing system a text message comprising at least a portion of information from a text message history between the endpoint device and the counterparty computing system (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical device(s) that provide(s) the ability to store information such as instructions and/or data to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
obtaining, by a processing system including at least one processor of an endpoint device, an authentication request from a counterparty computing system via a first text message, wherein the authentication request is based on a context associated with at least one of: the endpoint device, a user of the endpoint device, or the counterparty computing system;
retrieving, by the processing system, contextual content in response to the authentication request, wherein the contextual content comprises information from a text message history between the endpoint device and the counterparty computing system; and
transmitting, by the processing system to the counterparty computing system, a second text message comprising at least a portion of the information from the text message history.

2. The method of claim 1, wherein the information from the text message history comprises a text message content of one or more text messages of the text message history.

3. The method of claim 2, wherein the information from the text message history comprises metadata of the one or more text messages of the text message history.

4. The method of claim 3, wherein the metadata comprises one or more of:
timing information of the one or more text messages;
length information of the one or more text messages; or
data size information of the one or more text messages.

5. The method of claim 1, wherein the information from the text message history comprises an output of a security function in response to an input vector comprising text message history data from the text message history.

6. The method of claim 5, wherein the text message history data comprises a text message content of one or more text messages of the text message history.

7. The method of claim 5, wherein the text message history data comprises metadata of one or more text messages of the text message history.

8. The method of claim 5, wherein the retrieving of the contextual content comprises:
applying the input vector to the security function implemented by the processing system to obtain the output.

9. The method of claim 8, further comprising:
obtaining at least one of: the security function or a key associated with the security function.

10. The method of claim 1, wherein the contextual content further comprises:
location information of the endpoint device.

11. The method of claim 1, wherein the contextual content further comprises:
media file data accessible to the endpoint device.

12. The method of claim 1, wherein the contextual content is stored at the endpoint device.

13. The method of claim 1, wherein the contextual content further comprises:
information obtained from an application of the endpoint device.

14. The method of claim 1, wherein the contextual content is selected via an artificial intelligence agent implemented by the processing system.

15. The method of claim 14, wherein the artificial intelligence agent comprises a machine learning-based language model.

16. The method of claim 15, wherein the contextual content is selected via a retrieval augmented generation process.

17. The method of claim 1, wherein the authentication request comprises a query having an answer that is obtained from the context associated with the at least one of: the endpoint device, the user of the endpoint device, or the counterparty computing system.

18. The method of claim 1, wherein the first text message and the second text message comprise rich communication services messages.

19. A non-transitory computer-readable medium storing instructions which, when executed by a processing system including at least one processor of an endpoint device, cause the processing system to perform operations, the operations comprising:
obtaining an authentication request from a counterparty computing system via a first text message, wherein the authentication request is based on a context associated with at least one of: the endpoint device, a user of the endpoint device, or the counterparty computing system;
retrieving contextual content in response to the authentication request, wherein the contextual content comprises information from a text message history between the endpoint device and the counterparty computing system; and
transmitting, to the counterparty computing system, a second text message comprising at least a portion of the information from the text message history.

20. An apparatus comprising:
a processing system including at least one processor of an endpoint device; and
a non-transitory computer-readable medium storing instructions which, when executed by the processing system, cause the processing system to perform operations, the operations comprising:
obtaining an authentication request from a counterparty computing system via a first text message, wherein the authentication request is based on a context associated with at least one of: the endpoint device, a user of the endpoint device, or the counterparty computing system;
retrieving contextual content in response to the authentication request, wherein the contextual content comprises information from a text message history between the endpoint device and the counterparty computing system; and
transmitting, to the counterparty computing system, a second text message comprising at least a portion of the information from the text message history.
